(19) United States
(12) Patent Application Publication
(10) Pub. No.: US 2024/0222978 A1
(43) Pub. Date: Jul. 4, 2024

(54) Maximizing Power in a Photovoltaic Distributed Power System

(71) Applicant: Solaredge Technologies Ltd., Herzeliya (IL)

(72) Inventor: Ilan Yoscovich, Givatayim (IL)

(21) Appl. No.: 18/436,241

(22) Filed: Feb. 8, 2024

Related U.S. Application Data
(63) Continuation of application No. 16/787,730, filed on Feb. 11, 2020, now Pat. No. 11,929,620.
Application No. 16/787,730 is a continuation of application No. 15/720,919, filed on Sep. 29, 2017, now Pat. No. 10,608,553.
Application No. 15/720,919 is a continuation of application No. 13/754,059, filed on Jan. 30, 2013, now Pat. No. 9,812,984.

(30) Foreign Application Priority Data
Jan. 30, 2012 (GB) 1201499.9

(51) Int. Cl. H02J 3/38; H02J 3/46; H02M 7/42

(52) U.S. Cl. CPC H02J 3/381; H02J 3/38; H02J 3/46; H02M 7/42; H02J 2300/26; Y02E 10/56

(57) ABSTRACT

A power harvesting system including multiple parallel-connected photovoltaic strings, each photovoltaic string includes a series-connection of photovoltaic panels. Multiple voltage-compensation circuits may be connected in series respectively with the photovoltaic strings. The voltage-compensation circuits may be configured to provide respective compensation voltages to the photovoltaic strings to maximize power harvested from the photovoltaic strings. The voltage-compensation circuits may be include respective inputs which may be connected to a source of power and respective outputs which may be connected in series with the photovoltaic strings.

### CROSS-REFERENCE TO RELATED APPLICATIONS

This application is a continuation of U.S. application Ser. No. 16/787,730, filed Feb. 11, 2020, which is a continuation of U.S. application Ser. No. 15/720,919 filed Sep. 29, 2017, now U.S. Pat. No. 10,608,553, which is a continuation of U.S. application Ser. No. 13/754,059, filed Jan. 30, 2013, now U.S. Pat. No. 9,812,984, which claims priority to United Kingdom Application GB1201499.9 filed Jan. 30, 2012, the contents of which are hereby incorporated by reference in their entirety.

### BACKGROUND

### 1. Technical Field

The exemplary features presented relate to a photovoltaic power harvesting system including multiple photovoltaic strings and, more particularly to system and method for maximizing power in each photovoltaic string.

### 2. Description of Related Art

Reference is made to FIG. 1 which shows a photovoltaic power harvesting system 10 according to conventional art. A photovoltaic string 109 includes a series connection of photovoltaic panels 101. Photovoltaic strings 109 may be connected in parallel to give a parallel direct current (DC) power output. The parallel DC power output connects to the input of a direct current (DC) to alternating current (AC) inverter 103. The AC power output of inverter 103 connects across an AC load 105. AC load 105 may be an AC load such as an AC motor or may be an electrical power grid.

By way of a simplified numerical example, three strings 109 may be used with an inverter 103. If two strings 109 are equally irradiated such that each string operates with a string voltage of 600 volts (V) and string current of 10 amperes (A); each of the two strings generates (10 A·600 V) 6 kilowatts (kW). It is also assumed that the two equally irradiated strings 109 may be operating at maximum power.

If however, one string 109 is partially shaded or if one or more panels 101 is under performing, there may still be a string voltage of 600V as set by the other two equally irradiated strings 109, however, the string current in the one under performing string 109 may only be only 6 amperes. The under performing string 109 is not operating at maximum power point. For instance, it may be that the under performing string 109 has a maximum power point of 550 volts for a current of 10 amperes. In this situation, the power lost by the under performing string 109 is 1.9 kW (550V·10 A−600V·6 A). The under performing string 109, therefore, produces 3.6 kW (600V·6 A). Overall power harvested from system 10 is, therefore 15.6 kW (3.6 kW+2·6 kW).

Reference is now made to FIG. 2 which shows another power harvesting system 20 according to conventional art, according to international patent application publication WO2010002960. System 20 is directed to reduce power losses compared to the losses of system 10. Each photovoltaic string 109 includes a series connection of photovoltaic panels 101. Each photovoltaic string 109 is connected in parallel to an input of a DC-to-DC converter 205. The output of converter 205 connects to a DC bus 211. The DC voltage generated by photovoltaic string 109 is converted by converter 205 to the voltage of DC bus 211. Each photovoltaic string 109 together with the respective DC-DC converter 205 forms a photovoltaic string module 207. A number of modules 207 with outputs from respective DC-to-DC converters 205 may be connected in parallel to DC bus 211. The parallel combined outputs of modules 207 may be also connected to an input of a direct current (DC) to alternating current (AC) inverter 103 via DC bus 211. Inverter 103 converts the combined DC power outputs of modules 207 to an alternating current power at an output of inverter 103. The output of inverter 103 connects to AC load 105.

Still referring to FIG. 2, using the same numerical example as in system 10 (FIG. 1), three modules 207 may be used with inverter 103. Two strings 109 may be equally irradiated such that each string of the two strings operates with a string voltage of 600 volts and string current of 10 amperes. Each of the two strings generates (10 amperes·600 volts) or 6 kilowatts. If the one remaining string 109 is under performing, there may be maximum power point for the under performing string 109 of 550 volts and current of 10 amperes. Each DC-to-DC converter 205 may be configured to maximize power on each respective output to give 600 volts on DC bus 211. The two equally irradiated modules 207 each produce 6 kW (10 amperes·600 volts) and the under performing unit 207 produces 5.5 kW (10 amperes·550 volts). Giving an overall power harvested from system 20 of 17.5 kW. It can be seen that system 20 offers an improvement of 1.9 kW over system 10 in terms of minimized losses and increased power harvested. The improvement has been achieved through multiple DC-DC converters 205 which operate at wattage levels of around 6 kW. The high power DC-DC converters 205 in a power harvesting system may add to the cost of installation and maintenance of the power harvesting system and may present an overall decreased level of reliability for the power harvesting system because DC-DC converters 205 operate at high wattage levels.

The terms “monitoring”, “sensing” and “measuring” are used herein interchangeably.

The terms “power grid” and “mains grid” are used herein interchangeably and refer to a source of alternating current (AC) power provided by a power supply company.

The term “converter” as used herein applies to DC-to-DC converters, AC-to-DC converters, DC-to-AC inverters, buck converters, boost converters, buck-boost converters, full-bridge converters and half-bridge converters or any other circuit for electrical power conversion/inversion known in the art.

The term “DC load” as used herein applies to the DC inputs of converters, batteries, DC motors or DC generators.

The term “AC load” as used herein applies to the AC inputs of converters, transformers, AC motors or AC generators.

### BRIEF SUMMARY

Various power harvesting systems may be provided including multiple parallel-connected photovoltaic strings, each photovoltaic string includes a series-connection of photovoltaic panels. Multiple voltage-compensation circuits may be connected in series respectively with the photovoltaic strings. The voltage-compensation circuits may be configured to provide respective compensation voltages to the photovoltaic strings to maximize power harvested from the photovoltaic strings. The voltage-compensation circuits may include respective inputs which may be connected to a source of power and respective outputs which may be connected in series with the photovoltaic strings. The voltage-compensation circuits may be an alternating current (AC) to direct current (DC) converter where the source of power is a source of AC power, or a DC-of-DC converter where the source of power is a source of DC power. The source of power may be provided by the power grid.

The power harvesting system may include further, a direct current power output attached to the parallel-connected photovoltaic strings. The voltage-compensation circuits may include source power inputs connected to the direct current power output.

The power harvesting system may also include a direct current power output attached to the parallel-connected photovoltaic strings and an inverter including a DC power input attached to the direct current power output. The inverter preferably includes an AC power output. The inverter may be configured to invert direct current power generated by the parallel-connected photovoltaic strings to alternating current power at the AC power output. The voltage-compensation circuits may include source power inputs from the AC power output.

The power harvesting system may include a central controller operatively attached to the voltage-compensation circuits. The central controller may be adapted to control the compensation voltages by tracking maximum power produced from all the parallel-connected photovoltaic strings. A power sensor may be connected to the direct current power output and the central controller. The power sensor may be adapted to sense power in the direct current power output and report a sensed power to the central controller. The central controller may control the compensation voltages to maximize power from all the parallel-connected photovoltaic strings based on the sensed power.

The voltage-compensation circuits may be optionally configured to provide the compensation voltages in the photovoltaic strings additional to the voltages provided by the series connected photovoltaic panels.

The power harvesting system may also include, multiple sensors operatively connected respectively to the voltage-compensation circuits. The sensors may be adapted to measure a circuit parameter of the photovoltaic strings. The voltage-compensation circuits may be adapted to provide the compensation voltages based on the at least one circuit parameter to maximize power in the photovoltaic strings. The circuit parameter may include respective currents flowing in the photovoltaic strings. The at least one circuit parameter may include respective voltages of the photovoltaic strings.

According to features presented there is provided a power harvesting system which includes a photovoltaic string including a series connection of photovoltaic panels and a voltage-compensation circuit connected in series with the photovoltaic string. The voltage-compensation circuit may be configured to provide a compensation voltage to the string to maximize power harvested from the photovoltaic string. The voltage-compensation circuit may include an input connectible to a source of power and an output connectible in series with the photovoltaic string.

The power harvesting system may further include a direct current power output attached to the photovoltaic string. The voltage-compensation circuit includes a DC-to-DC converter having a source power input connected to the direct current power output. The voltage-compensation circuit may have an AC-to-DC converter with an alternating current (AC) source input provided from an AC power source. The AC-to-DC converter also includes a DC output which connects in series with the photovoltaic string. A direct current power output attached to the photovoltaic string and an inverter having a DC inverter input connected to the direct current power output. The AC-to-DC converter may be connectible at the AC source input to either a power grid, or an AC output of the inverter.

According to features presented there is provided a method in a power harvesting system which includes a photovoltaic string. The photovoltaic string may include a series-connection of photovoltaic panels. The method connects in series a voltage-compensation circuit within the photovoltaic string. A circuit parameter may be monitored within the photovoltaic string. A compensation voltage of the voltage-compensation circuit may be configured based on the monitoring. The compensation voltage may be added serially within the photovoltaic string, thereby maximizing the power harvested from the photovoltaic string. A DC load may be attached to the photovoltaic string. An input of the voltage-compensation circuit may be connected to either a source of AC power or a source of DC power. The circuit parameter may include a current produced by the photovoltaic string, a voltage across the photovoltaic string or the power produced by the photovoltaic string.

### BRIEF DESCRIPTION OF THE DRAWINGS

The invention is herein described, by way of example only, with reference to the accompanying drawings, wherein:

FIG. 1 shows a photovoltaic power harvesting system according to conventional art.

FIG. 2 shows another photovoltaic power harvesting system according to conventional art.

FIG. 3a shows a power harvesting system according to a feature of the present invention.

FIG. 3b shows a power harvesting system according to another feature of the present invention.

FIG. 3c shows more details of a voltage-compensation circuit shown in FIGS. 3a and 3b, according to a feature of the present invention.

FIG. 3d shows an implementation of a voltage-compensation circuit shown in FIGS. 3a and 3b, according to another feature of the present invention.

FIG. 4 shows a method applied to the power harvesting systems shown in FIGS. 3a and 3b, according to a feature of the present invention.

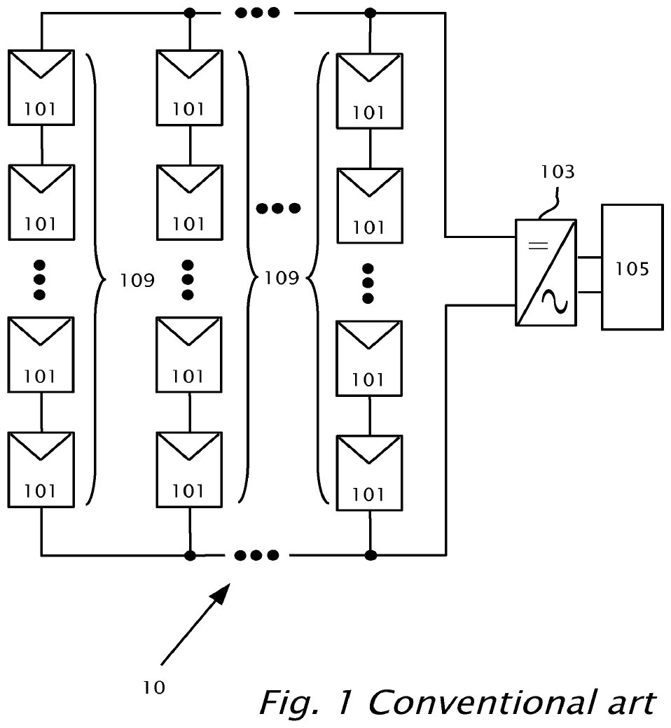

### DETAILED DESCRIPTION

Reference will now be made in detail to features of the present invention, examples of which are illustrated in the accompanying drawings, wherein like reference numerals refer to the like elements throughout. The features are described below to explain the present invention by referring to the figures.

Before explaining features of the invention in detail, it is to be understood that the invention is not limited in its application to the details of design and the arrangement of the components set forth in the following description or illustrated in the drawings. The invention is capable of other features or of being practiced or carried out in various ways. Also, it is to be understood that the phraseology and terminology employed herein is for the purpose of description and should not be regarded as limiting.

It should be noted, that although the discussion herein relates primarily to photovoltaic systems, the present invention may, by non-limiting example, alternatively be configured using other distributed power systems including (but not limited to) wind turbines, hydro turbines, fuel cells, storage systems such as battery, super-conducting flywheel, and capacitors, and mechanical devices including conventional and variable speed diesel engines, Stirling engines, gas turbines, and micro-turbines.

By way of introduction, features of the present invention are directed towards maximizing output power from under-performing or partially shaded photovoltaic strings in a power harvesting system of parallel connected photovoltaic strings. The features may provide maximal overall power output of the system and reduced installation and maintenance cost of the system. The features may also provide increased reliability of the system, owing to lower power operating levels of switching converters added to each of the photovoltaic string compared with DC-DC converters 205 used in conventional system 20.

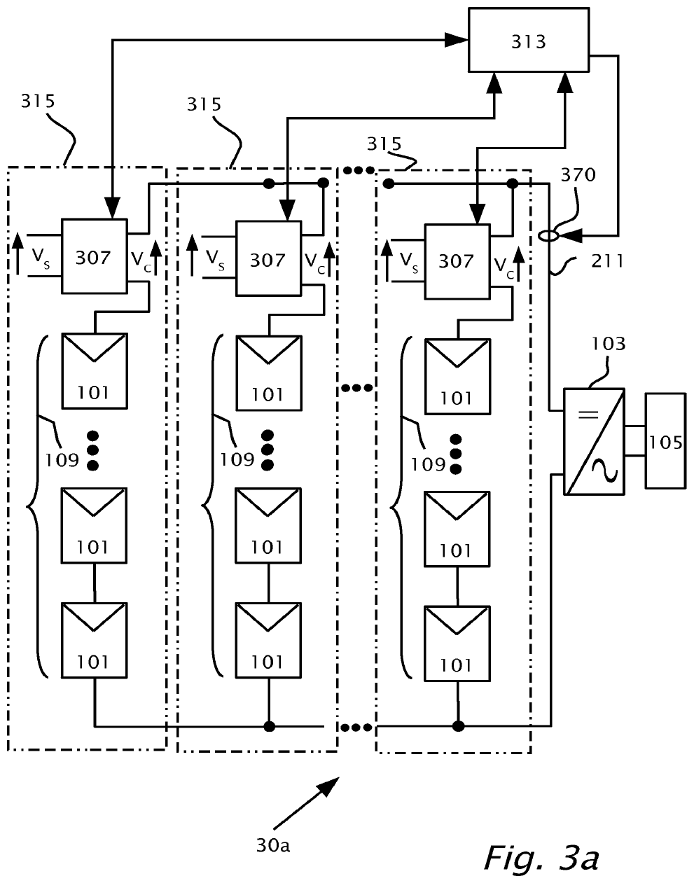

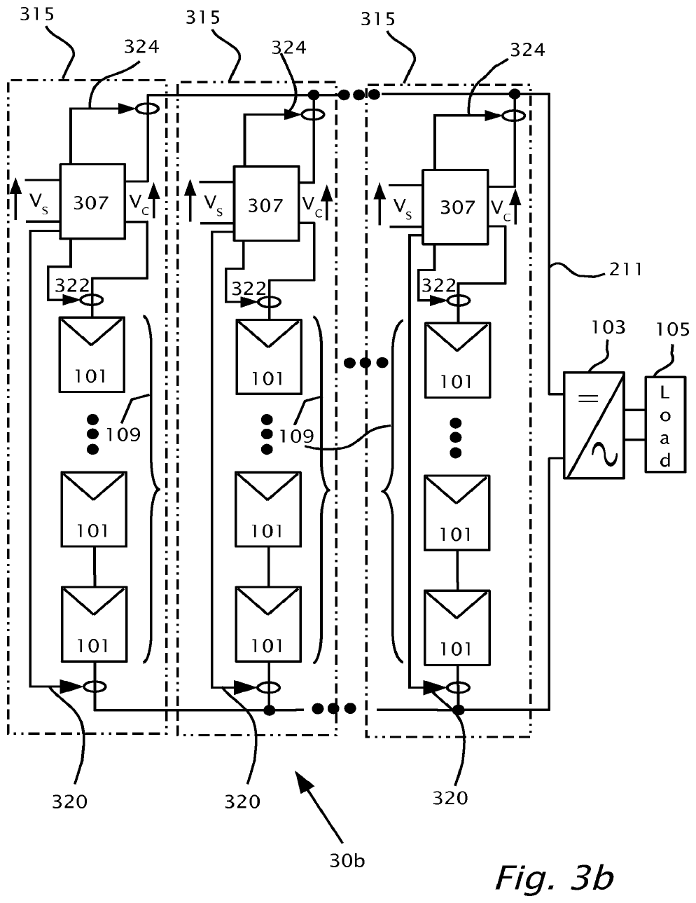

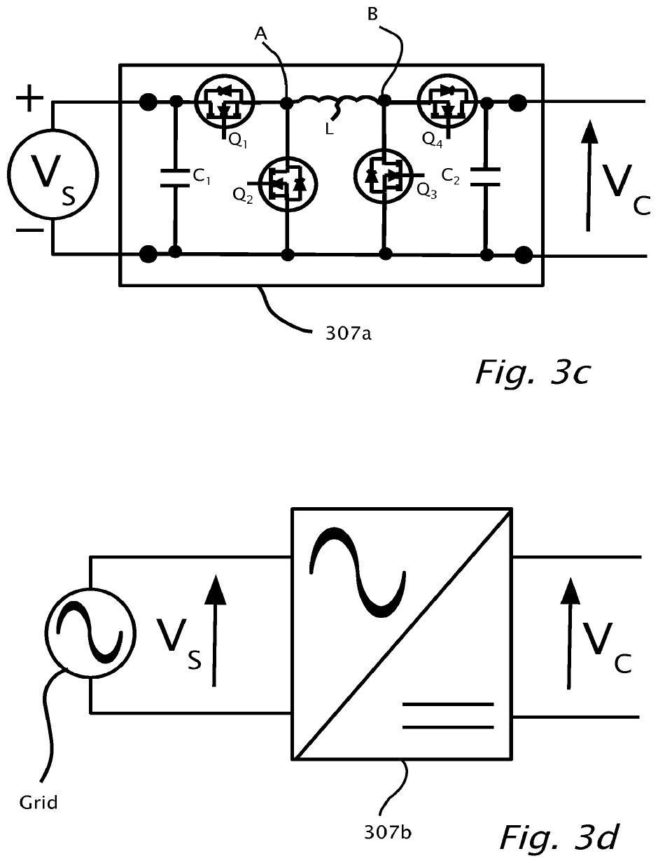

Reference is now made to FIG. 3a which shows a power harvesting system 30a according to a feature of the present invention. A number of photovoltaic panels 101 are connected in series to form a photovoltaic string 109. String 109 is connected in series with a voltage-compensation circuit 307 to provide a compensated string 315. A source voltage (V_{S}) may be input to voltage-compensation circuit 307. A number of compensated strings 315 may be connected together in parallel to give direct current (DC) power output 211. A power sensor 370 operatively connected to central controller 313 measures the power on DC output 211. DC power output 211 is connected to an input of a DC to alternating current (AC) inverter 103. Inverter 103 converts the combined DC power output 211 of strings 315 to an alternating current power at an output of inverter 103. The output of inverter 103 connects to AC load 105. A central controller 313 may be operatively attached to each voltage-compensation circuit 307 by bi-directional control and communication lines as shown, by wireless communication or by power line communications in DC bus 211. Central controller 313 may include a microprocessor with on-board memory and an interface which may include analogue to digital converters (ADCs) and digital to analogue converters (DACs).

Reference is now made to FIG. 3b which shows a power harvesting system 30b according to another feature of the present invention. String 109 is connected in series with voltage-compensation circuit 307 to provide a compensated string 315. A source voltage (V_{S}) may be input to voltage-compensation circuit 307. A number of compensated strings 315 may be connected together in parallel to give direct current (DC) power output 211. DC power output 211 is connected to an input of a DC to alternating current (AC) inverter 103. Inverter 103 converts the combined DC power output 211 of strings 315 to an alternating current power at an output of inverter 103. The output of inverter 103 connects to AC load 105. System 30a is the same as system 30b except that system 30b does not have central controller 313. Instead, monitoring and control in system 30b is performed by each circuit 307, which may include a microprocessor with on-board memory and an interface which may include analogue to digital converters (ADCs) and digital to analogue converters (DACs). Each circuit 307 is operatively attached to sensors 320, 322 and 324. Sensors 320 and 322 may be adapted to sense the voltage across photovoltaic string 109 as well as current in string 109. Alternatively, sensors 320 and 324 may be adapted to sense the voltage across a compensated string 315 and current in string 315. Alternatively, sensors 324 and 322 may be adapted to sense the voltage (V_{C}) across a circuit 307 as well as current through the circuit 307.

Reference is now made to FIG. 3c which shows more details of voltage-compensation circuit 307 shown in FIGS. 3a and 3b, according to a feature of the present invention. Voltage-compensation circuit 307 may be implemented using a direct current (DC) to DC converter 307a. DC-to-DC converter 307a may be a buck circuit, a boost circuit, a buck+boost circuit or switched-mode power supply (SMPS). The output of DC-to-DC converter 307 is connected in series within string 315 to add compensation voltage (V_{C}) to string 315. The DC source voltage input (V_{S}) to DC-to DC converter 307 may be provided from the combined DC output of strings 315, or strings 109. Alternatively, DC source voltage input (V_{S}) may be provided by a micro-inverter converting AC from the mains grid or another independent source of DC power such as a battery or DC generator. Circuit 307 as shown in FIG. 3c, is a conventional buck-boost DC-to-DC converter circuit which has an input voltage V_{S} with an input capacitor C₁ connected in parallel across V_{S}. Two switches may be implemented as field effect transistors (FET) with integral diodes: a high side buck switch Q₁ and a low side buck switch Q₂ connected in series by connecting the source of Q₁ to the drain of Q₂. The drain of Q₁ and the source of Q₂ may be connected parallel across the input capacitor C₁. A node A is formed between switches Q₁ and Q₂ to which one end of an inductor L is connected. The other end of inductor L is connected to the boost circuit of buck-boost DC-to-DC converter 307 at a node B. Node B connects two switches implemented as field effect transistors (FET): a high side boost switch Q₄ and a low side boost switch Q₃ together in series where the source of Q₄ connects to the drain of Q₃ to form node B. The drain of Q₄ and the source of Q₃ connect across an output capacitor C₂ to produce the output voltage V_{C} of buck-boost DC-to-DC converter 307.

Reference is now made to FIG. 3d which shows an implementation of circuit 307 shown in FIGS. 3a and 3b, according to another feature of the present invention. Voltage compensation circuit 307 may be implemented using an alternating current (AC) to DC inverter. The AC to DC inverter 307b may be a type of switched mode power supply (SMPS). When voltage-compensation circuit 307 is an AC to DC converter 307b, the DC output of the AC to DC converter is connected in series within a string 315. The AC input (Vₛ) to the AC to DC converter may be provided from the mains grid, from the AC output of inverter 103 or by another independent source of AC power.

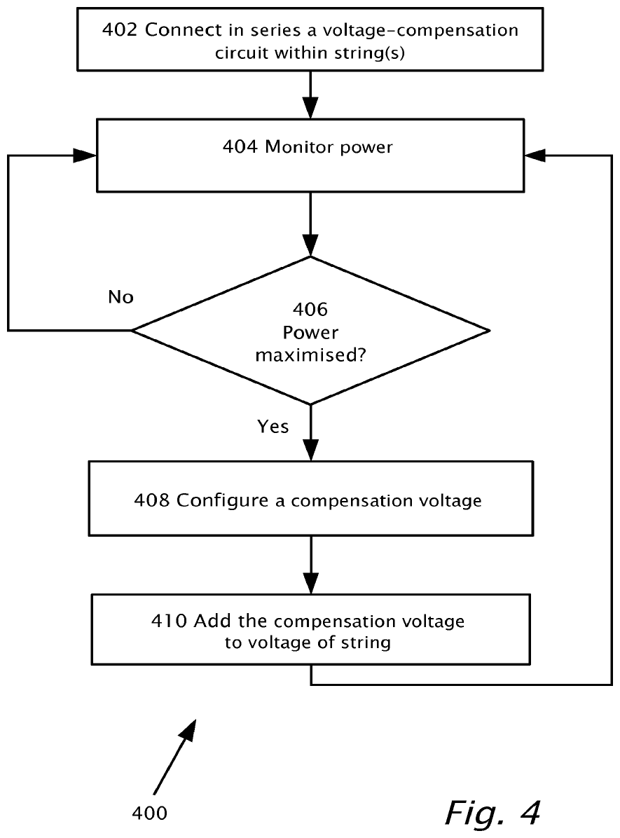

Reference is now made to FIG. 4 which shows a method 400 which may be applied to power harvesting system 30b shown in FIG. 3b, according to a feature of the present invention. In step 402, an output voltage (V_{C}) of circuit 307 is wired in series with a series-connection of panels 101 to form compensated string 315. The input voltage (V_{S}) to circuit 307 may be from direct current (DC) output 211, the alternating current (AC) output of inverter 103 or a separate independent AC or DC electric supply. Several compensated strings 315 outputs may then be connected in parallel and further connected to the input of an inverter 103 as shown in FIG. 3b.

In step 404, a circuit parameter of each parallel connected string 315 is monitored in the case of system 30b. The circuit parameter may be the current flowing in a string 315, the voltage across a string 315, the voltage of a photovoltaic string 109 and/or the voltage (V_{C}) across a circuit 307. The current and voltages in a string 315 may be used to determine the power (P) in a string 315 or a photovoltaic string 109 by virtue of power being equal to voltage (V) multiplied by current (I).

In decision block 406, a control algorithm stored in a circuit 307 adjusts compensation voltage V_{C} to maximize output power of string 315. In step 408, a compensation voltage V_{c} for strings 315 is configured based on the result of the control algorithm performed in steps 404 and 406. The compensation voltage V_{c} for strings 315 in step 408 may be a positive or a negative voltage polarity with respect to the voltage polarity of a string 109. In step 410, the compensation voltage V_{c} is added to string 315. In the case of the positive voltage for V_{c}, the voltage of a string 315 may be increased in step 408. In the case of the negative voltage for V_{c}, the voltage of string 315 may be decreased in step 408.

Reference is still being made to FIG. 4. Method 400 may also be applied to system 30a (FIG. 3a) which uses central controller 313. In the case of system 30a, in step 404 central controller monitors or calculates a net total power from system 30a. The net total power from system 30a is equal to the power produced by strings 109 subtracted from the power added by compensation circuits 307.

When the voltage (V_{S}) and hence power to the input of circuit 307 is derived from DC bus 211 or the output of inverter 103 to give compensated voltage (V_{C}). The net total power from system 30a may be derived directly by monitoring (step 404) power on DC bus 211.

When the voltage (V_{S}) and hence power to the input of circuit 307 is derived from an independent DC source or AC source such as a mains supply to give compensated voltage (V_{C}). The net total power from system 30a may be derived by subtracting power monitored on DC Bus 211 (step 404) from the power added by compensation circuits 307.

In decision block 406, compensation voltages V_{c} of all strings 315 may be adjusted to maximize the net total power from system 30a. In step 408, a compensation voltage V_{c} for a string 315 is configured based on the result of the control algorithm performed in steps 404 and 406. In step 410, the compensation voltage V_{c} is added to a string 315.

During a sustained use of systems 30a or 30b over a period of time, the number and type of serial connected panels 101 in a string 315 may change, some panels may become faulty and/or operate in a current bypass mode or panels may be replaced with ones that have different electrical characteristics. Under these circumstances, the control algorithm maintains strings 315 at their maximum power point (MPP) by adding compensation voltage to each string 315 to maintain maximum power from each string 315. When all strings 109 are found to be operating at maximum power output level and maximum power point, no voltage compensation V_{c} may be required and voltage compensation V_{c} added to string 315 is at or near zero volts.

With respect to both systems 30a and 30b. In each iteration of the control algorithm performed in steps 404 and 406, it may be possible to subtract from all the compensation voltages (V_{c}) in each string 315, the minimum compensation voltage V_{c}. Subtracting the minimum compensation voltage V_{c}, may prevent a drift in the compensation voltages (V_{c}) going too high for no reason. Alternatively, it may be possible to tie the compensation voltages (V_{c}) to a level that will optimize the overall voltage of strings 315 to be optimal for the input of inverter 103, thereby increasing the conversion efficiency of inverter 103.

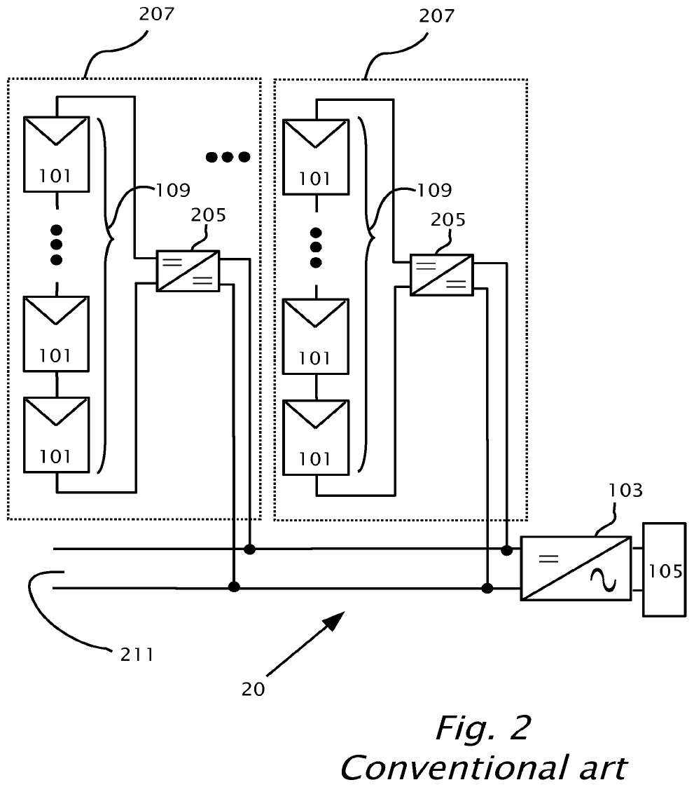

The present features with respect to method 400 and systems 30a or 30b, may be compared to conventional system 20 (FIG. 2) by way of the same numerical example, where three compensated strings 315 are used. It may be assumed just for the purpose of the numerical example that the three compensated strings 315 are compensated by circuit 307 which may be an AC to DC converter powered from the grid. Therefore, circuit 307 receives and converts voltage (V_{S}) and hence power from the electrical grid. If two strings 109 are equally irradiated such that each string operates with a string 109 voltage of 600 volts and string current of 10 amperes, each of the two strings generates (10 amperes·600 volts) 6 kilowatts. If one under-performing string 109 is partially shaded or if a panel 101 is removed or bypassed, there may be a string voltage of 550 Volts and current of 10 amperes, which means (10 amperes·550 volts) 5.5 kilowatts may be generated by the under-performing string 109. The maximum power 5.5 kilowatts may be generated by the under-performing string 109 only if the under-performing string 109 can be operated at maximum power point (MPP).

Voltage-compensation circuit 307 of the under-performing string 109 may be configured (step 408) by controller 313 to add 50 volts (V_{C}) in series with under-performing string 109 while maintaining the current of 10 amperes (step 410). Adding 50 volts by use of voltage-compensation circuit 307, maintains string 315 voltage at 600 volts also for under-performing string 109. Increasing the voltage of the string 315, allows the one under-performing string 109 to operate at MPP and also requires an extra (10 amperes·50 volts) 500 Watts when compared to the 6 kilowatts in each of the other two strings 315. The overall power output of system 30a or 30b is 18 kilowatts, from two strings 109 providing 12 kilowatts (2·6 kilowatts), the under-performing compensated string 109 providing 5.5 kilowatts and the grid providing 500 watts (50 volts·10 amperes) via circuit 307. The power provided from the 3 strings 315 may be therefore, the same as system 20 at 17.5 kilowatts (2·6 kilowatts+5.5 kilowatts).

The benefit of systems 30 compared with system 20 is that 500 W-1 kW switching converters 307 may be required compared with 6-10 kW switching converters used in system 20. The difference in power rating may represent a huge improvement in cost and reliability of systems 30 compared with system 20.

The indefinite articles “a”, “an” is used herein, such as “a string”, “a voltage-compensation circuit” have the meaning of “one or more” that is “one or more strings” or “one or more voltage-compensation circuits”.

Although selected features of the present invention have been shown and described, it is to be understood the present invention is not limited to the described features. Instead, it is to be appreciated that changes may be made to these features without departing from the principles and spirit of the invention, the scope of which is defined by the claims and the equivalents thereof.

1. A system comprising:
first converter circuitry configured to convert an input voltage between a pair of input terminals to a converter output voltage across a pair of output terminals;
an input power source connected to the input terminals;
a first photovoltaic (PV) power source connected to one terminal of the pair of output terminals and configured to output a first PV output voltage, wherein the converter output voltage together with the first PV output voltage is a combined output voltage;
a system power device connected to the first converter circuitry and the first PV power source and configured to receive the combined output voltage;
a second PV power source configured to output a second PV output voltage, and
controller circuitry configured to control the converter output voltage based on the second PV output voltage.

2. The system of claim 1, wherein the controller circuitry is configured to control the converter output voltage based on a maximum power of the second PV power source.

3. The system of claim 1, wherein the controller circuitry is configured to control the converter output voltage based on a maximum power of the first PV power source.

4. The system of claim 1, wherein the controller circuitry is configured to control the converter output voltage based on a first maximum power of the first PV power source and a second maximum power of the second PV power source.

5. The system of claim 1, wherein the controller circuitry is configured to control the converter output voltage based on a first power of the first converter circuitry, a second power of the first PV power source, and a third power of the second PV power source.

6. The system of claim 1, wherein the controller circuitry is configured to control the converter output voltage based on a first current of the first converter circuitry and the first PV power source, and a second current of the second PV power source.

7. The system of claim 1, wherein the first converter circuitry includes direct current (DC) to DC converter circuitry.

8. The system of claim 1, wherein the first converter circuitry includes buck converter circuitry and boost converter circuitry.

9. The system of claim 1, wherein the system power device includes second converter circuitry.

10. The system of claim 9, wherein the second converter circuitry includes direct current (DC) to alternating current (AC) converter circuitry.

11. The system of claim 1, wherein the system further includes third converter circuitry with an output terminal connected to the second PV power source and configured to output a second converter output voltage, wherein the second PV output voltage together with the second converter output voltage is a second combined output voltage.

12. The system of claim 11, wherein the system power device is connected to the third converter circuitry and the third power source and configured to receive the second combined output voltage.

13. The system of claim 12, wherein the controller circuitry is configured to control the converter output voltage based on the second combined output voltage.

14. The system of claim 12, wherein the controller circuitry is configured to control the converter output voltage based on the combined output voltage and the second combined output voltage.

15. An apparatus comprising:
a pair of input terminals,
a pair of output terminals including a first output terminal and a second output terminal;
converter circuitry configured to convert an input voltage between the pair of input terminals to a converter output voltage across the pair of output terminals;
an input power source connected to the pair of input terminals;
wherein the first output terminal of the pair of output terminals is configured to connect to a first photovoltaic (PV) power source;
wherein the second output terminal of the pair of output terminals is configured to connect to a system power device; and
controller circuitry configured to control the converter output voltage based on a PV output voltage generated by a second PV power source.

16. The apparatus of claim 15, wherein the controller circuitry is configured to control the converter output voltage based on a maximum power of the second PV power source.

17. The apparatus of claim 15, wherein the controller circuitry is configured to control the converter output voltage based on a maximum power of the first PV power source.

18. The apparatus of claim 15, wherein the controller circuitry is configured to control the converter output voltage based on a first maximum power of the first PV power source and a second maximum power of the second PV power source.

19. The apparatus of claim 15, wherein the controller circuitry is configured to control the converter output voltage based on a first power of the converter circuitry, a second power of the first PV power source, and a third power of the second PV power source.

20. The apparatus of claim 15, wherein the controller circuitry is configured to control the converter voltage based on a first current of the converter circuitry and the first PV power source, and a second current of the second PV power source.
